(19) United States
(12) Patent Application Publication
(10) Pub. No.: US 2021/0130219 A1
(43) Pub. Date: May 6, 2021

(54) DEVICE FOR EDGE FINISHING BRITTLE MATERIAL SUBSTRATE AND METHOD FOR EDGE FINISHING BRITTLE MATERIAL SUBSTRATE

(71) Applicant: KAWASAKI JUKOGYO KABUSHIKI KAISHA, Kobe-shi (JP)

(72) Inventors: Osami OOGUSHI, Kobe-shi (JP); Hideyuki TANAKA, Kobe-shi (JP)

(21) Appl. No.: 16/478,231

(22) PCT Filed: May 15, 2017
(86) PCT No.: PCT/JP2017/018135

§ 371 Date: Jul. 16, 2019

(30) Foreign Application Priority Data
Jan. 16, 2017 (JP) 2017-004919

(51) Int. Cl. C03B 33/033; C03C 19/00

(52) U.S. Cl. CPC C03B 33/033; B24B 9/10; C03C 19/00

(57) ABSTRACT

An edge finishing device for a glass substrate as a brittle material substrate includes a first heating part and a second heating part. The first heating part heats an edge of the glass substrate to melt the edge for smoothing an unevenness. The second heating part heats near a position to be smoothed by the first heating part of a plate surface of the glass substrate at a temperature lower than a heating temperature of the first heating part.

### TECHNICAL FIELD

The present invention relates to a device for an edge finishing brittle material substrate and a method for finishing the edge of the brittle material substrate.

### BACKGROUND ART

A conventional method of a polishing process such as a mechanically polishing an edge of a brittle material substrate such as a glass substrate has been generally performed in order to finish the edge of the brittle material substrate. Patent Document 1 discloses an end surface processing method for finishing an edge of plate glass by performing such polishing processing.

In the end surface processing method of Patent Document 1, in order to make the edge of the flat glass smooth in a few steps, a plurality of flat glass sheets obtained by dividing the flat glass material are stacked to form a split glass stack block. Then, a flat abrasive surface of a rotating grinding wheel grinds the end surface. Then, the end surface of the divided glass stack block is further mechanically ground by a rotating brush having a lot of flexible brush parts radially provided on the outer circumference, thereby finishing the edge.

### PRIOR-ART DOCUMENTS

### Patent Documents

PATENT DOCUMENT 1: Japanese Patent Application Laid-Open No. 2010-269389

### SUMMARY OF THE INVENTION

### Problems to be Solved by the Invention

However, when the edge of the flat glass is finished by the method of the above Patent Document 1, although the surface roughness of the edge can be made small by performing the finishing process, there is some possibility that tiny defects still remain at the edge. In the case where there are tiny defects at the edge of the brittle material substrate such as flat glass, a strength of this portion is not generally sufficient. Therefore, cracking or chipping easily occur from the portion, and there is room for improvement.

The present invention has been made in view of the above circumstances, and its potential object is to improve a strength of a brittle material substrate and prevent cracking or chipping.

### Means for Solving the Problems

Problems to be solved by the present invention are as described above, and next, means for solving the problems and effects thereof will be described.

According to a first aspect of the present disclosure, an edge finishing device for a brittle material substrate having the following configuration is provided. That is, the edge finishing device of the brittle material substrate includes a first heating part and a second heating part. The first heating part heats an edge of the brittle material substrate to melt the edge for smoothing an unevenness. The second heating part heats near a position to be smoothed by the first heating part of a plate surface of the brittle material substrate at a temperature lower than a heating temperature of the first heating part.

According to a second aspect of the present disclosure, a method for finishing an edge of a brittle material is provided. The method includes a smoothing step for smoothing an unevenness of an edge of the brittle material substrate by heating and melting the edge by a first heating part at a temperature higher than a heating temperature of a second heating part while the second heating part heats near a position to be smoothed of a plate surface of the brittle material substrate.

According to the first aspect or the second aspect, the edge of the brittle material substrate is melted by heating by the first heating part. Thereby, the unevenness such as flaws of the edge is smoothed and the strength of the edge can be improved. Since the near position to be smoothed of a plate surface is heated at a temperature lower than a heating temperature of the first heating part, there is a portion where the second heating part heats to medium temperature between a portion heated to high temperature for smoothing and an unheated portion. Thereby, residual tensile stress hardly generates. It may be possible to generate compressive stress depending on the conditions of heating. This can prevent cracking and chipping of the brittle material substrate.

### Effects of the Invention

According to one aspect of the present disclosure, a strength of a brittle material substrate can be improved to prevent cracking or chipping.

### BRIEF DESCRIPTION OF THE DRAWINGS

FIG. 1 A plan view schematically showing an edge finishing device for a brittle material substrate according to an embodiment of the present disclosure, and the brittle material substrate whose edge is finished by the edge finishing device.

FIG. 2 A front view schematically showing an edge finishing device and a brittle material substrate.

FIG. 3 A side view schematically showing the edge finishing device and the brittle material substrate.

FIG. 4 A view schematically showing a configuration of a first heating part and a second heating part.

FIG. 5 A plan view schematically showing a repair edge finishing device and the brittle material substrate whose edge is repaired by the repair edge finishing device.

FIG. 6 A plan view schematically showing an edge finishing device according to a first modification.

FIG. 7 A plan view schematically showing an edge finishing device according to a second modification.

FIG. 8 A plan view schematically showing an edge finishing device according to a third modification.

FIG. 9 A block diagram showing flow of steps of a method for finishing an edge of a brittle material substrate according to an embodiment of the present disclosure.

### EMBODIMENT FOR CARRYING OUT THE INVENTION

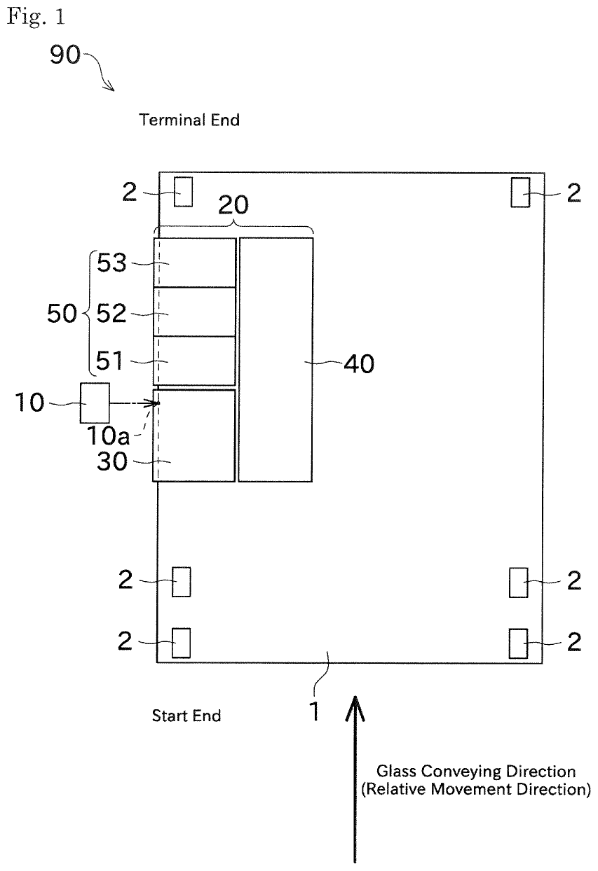

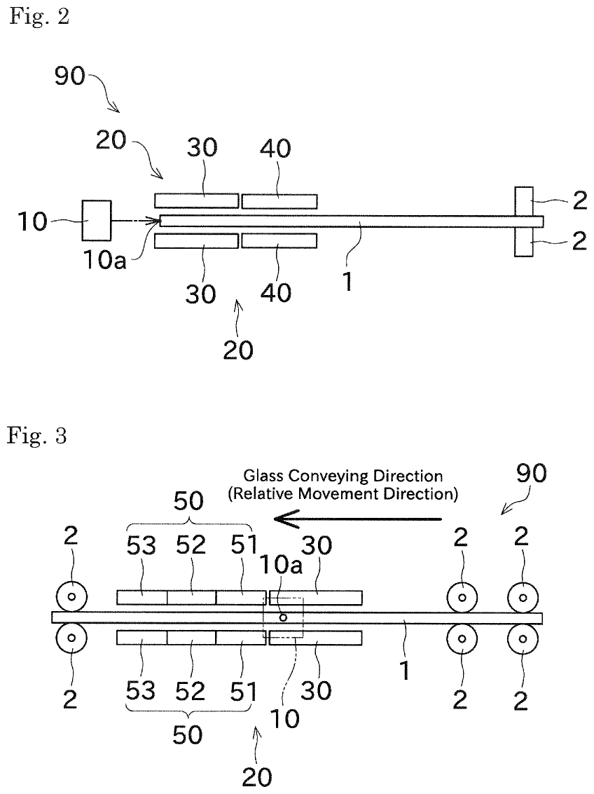

Next, an embodiment of the present disclosure will be described with reference to the drawings. FIG. 1 is a plan view schematically showing an edge finishing device 90 according to an embodiment of the present disclosure and a glass substrate 1 whose edge is finished by the edge finishing device 90. FIG. 2 is a front view schematically showing the edge finishing device 90 and the glass substrate 1. FIG. 3 is a side view schematically showing the edge finishing device 90 and the glass substrate 1.

The edge finishing device for the brittle material substrate (hereinafter sometimes referred to as “edge finishing device”) 90 of this embodiment performs finishing process for reducing a surface roughness of an edge (edge portion) of a glass substrate (glass plate) which is an example of a brittle material substrate by melting the edge using a heating and melting method.

The glass substrate 1 is formed as a rectangular plate having a certain thickness. The glass substrate 1 is supported, in a horizontal state, while being sandwiched between conveyance rollers 2 arranged in pairs. The thickness and the like of the glass substrate 1 is exaggeratedly shown in drawings. The conveyance rollers 2 are connected to an electric motor (not shown) as a driving source. The conveyance rollers 2 are driven by the electric motor, which can horizontally convey the glass substrate 1.

The edge finishing device 90 of this embodiment is arranged near the glass substrate 1. The edge finishing device 90 mainly includes a first heating part 10 and a second heating part 20.

Before the edge finishing process by the edge finishing device 90, the glass substrate 1 is cut into a suitable size according to the product size or the like, and then the edge (edge portion) is mechanically chamfered by grinding process. A polishing process is performed to the edge of the chamfered glass substrate 1 by melting the edge by the first heating part 10 of the edge finishing device 90. This can remove minute defects of the edge (an unevenness of the surface become smooth) and the surface roughness is reduced to perform the finishing.

The glass substrate 1 is conveyed by the conveyance rollers 2 while being positioned so that an end surface of the glass substrate 1 is located at a laser beam irradiation position (hereinafter referred to as a “polishing position”) 10a of the first heat part 10. The glass substrate 1 is conveyed, and thereby, in the glass substrate 1, the end surface of the edge facing the first heat part 10 sequentially passes through the polishing position 10a from one end to the other end in a conveying direction. In this embodiment, at the polishing position 10a, laser beam is irradiated on the end surface of the glass substrate 1, and thereby the end surface of the glass substrate 1 is heated to high temperature (for example, 1000° C.) and melted. This can achieve polishing process. In other words, the edge of the glass substrate 1 can be melted by a heating and melting method, and the edge can be smoothed and finished into a mirror surface. The first heating part 10 may be configured to include, for example, an element that oscillates a suitable laser beam such as a semiconductor laser or a gas laser, or may include another heat source such as a gas heater or a halogen heater.

A second heating part 20 is arranged in the vicinity of the first heating part 10 so as to face the plate surface of the glass substrate 1. The second heating part 20 can heat a particular region of the plate surface of the glass substrate 1 before and after performing the polishing process on the edge of the glass substrate 1, and at the same time of performing the polishing process.

In this embodiment, the glass substrate 1 is performed to the polishing process (edge finishing) while moving the glass substrate 1 relative to the first heating part 10 and the second heating part 20. Therefore, the glass substrate 1 relatively moves to the first heating part 10 and the second heating part 20. Hereinafter, a direction in which the glass substrate 1 relatively moves to the first heating part 10 and the second heating part 20 (the direction indicated by a bold arrow in FIG. 1 and FIG. 3) may be referred to as a “relative movement direction”. Regarding an region where the second heating part 20 heats the glass substrate 1, an end positioned on an upstream side in the relative movement direction may be referred to as a “start end”, and an end positioned on a downstream side in the relative movement direction may be referred to as a “terminal end”.

The conveyance rollers 2 movably support the glass substrate 1 at a position apart from both the position where the glass substrate 1 is polished and the position where the glass substrate 1 is heated by the second heat part 20. That is, the conveyance rollers 2 support a relatively low temperature portion of the glass substrate 1. Accordingly, the glass substrate 1 can be positioned and conveyed. The glass substrate 1 may be positioned and conveyed by another configuration such as a moving shuttle, a chuck, or the like instead of the conveyance rollers 2.

The second heating part 20 is a device for heating a particular region of the plate surface of the glass substrate 1 along with relative movement of the glass substrate 1. The second heating part 20 of this embodiment is arranged so as to face the plate surface of the glass substrate 1 on both sides in the thickness direction. More specifically, the second heating part 20 includes a main heating part 30, a peripheral heating part 40, and annealing part 50. In the case where a thickness of the glass substrate 1 is thin, for example, the second heating part 20 may be provided only on one side in the thickness direction of the glass substrate 1.

The second heating part 20 of this embodiment is arranged close to a conveyance path of the glass substrate 1 so as to sequentially heat the plate surface near the polishing position 10a of the glass substrate 1.

As shown in FIG. 1 to FIG. 3 the main heating part 30 is arranged near the above-described polishing position 10a, and partially heats the glass substrate 1. The main heating part 30 heats the glass substrate 1 to a temperature that is near a softening point and slightly lower than a softening point of the glass (for example, 800° C.).

As shown in FIG. 1, as seen in the thickness direction of the glass substrate 1, on a particular rectangular region (hereinafter may be referred to as a “main heating region”) in the second heating part 20, the main heating part 30 heats a portion facing such region of the glass substrate 1. The main heating region has a certain width in the direction perpendicular to the relative movement direction of the glass substrate 1. The main heating region includes a portion positioned on an upstream side from the polishing position 10a, in the relative movement direction of the glass substrate 1. Accordingly, the edges of the glass substrate 1 and its peripheral portion are preheated prior to polishing. This can reduce a temperature rise range due to polishing by the first heating part 10, and can prevent a large temperature difference between the polishing portion and its vicinity.

The peripheral heating part 40 shown in FIG. 1 and FIG. 2 partially heats the glass substrate 1. When viewed in the thickness direction of the glass substrate 1, the peripheral heating part 40 is arranged opposite to the polishing position 10a via the main heating part 30, and is arranged adjacent to the main heating part 30. In other words, the peripheral heating part 40 is, in a direction perpendicular to the relative movement direction of the glass substrate 1, arranged adjacent to the main heating part 30, and arranged on a side farther than the main heating part 30 as seen from the polishing position 10a. Therefore, a rectangular region where the peripheral heating part 40 heats the glass substrate 1 (hereinafter may be referred to as a “peripheral heating region”) is adjacent to the above-described main heating region. A start end of the main heating region and a start end of the peripheral heating region are almost identical in the relative movement direction of the glass substrate 1. Furthermore, the peripheral heating region is arranged so as to correspond to a region combining the main heating region and an annealing region which will be described later, in a direction perpendicular to the relative movement direction of the glass substrate 1. The peripheral heating part 40 heats the glass substrate 1 facing the peripheral heating region to a temperature equal to or lower than the strain point of the glass and close to the strain point (for example, 550° C.).

Accordingly, the glass substrate 1 has one portion where the main heating part 30 heats to high temperature to some extent and another portion where the peripheral heating part 40 heats to medium temperature. The portions are between a portion where the main heating part 10 heats to high temperature and an unheated portion. That is, the glass substrate 1 is heated to low temperature stepwisely as a portion goes away from the polishing position 10a. Therefore, in the glass substrate 1, positional temperature gradient between the heated portion and the unheated portion becomes gentle. Even when the glass substrate 1 is cooled after the edge finishing process, residual tensile stress hardly generates at the boundary between the heated portion and the unheated portion. It may be possible to generate compressive stress applied to the boundary depending on the conditions of heating.

The annealing/slow-cooling part 50 shown in FIG. 1 and FIG. 3 is a part for heating in order to have gentle temperature drop of a portion of the plate surface of the glass substrate 1 where the polishing process is performed after polishing by the first heating part 10. The annealing part 50 is arranged adjacent to the main heating part 30, and arranged downstream of the main heating part 30 in the relative movement direction of the glass substrate 1. Therefore, the rectangular region heated by the annealing part 50 for annealing (hereinafter may be referred to as an “annealing region”) is adjacent to the above-described main heating region, in a downstream side of the relative movement direction of the glass substrate 1. The annealing region has the same width as the main heating region in the direction perpendicular to the relative movement direction of the glass substrate 1. The annealing part 50 is also arranged adjacent to the peripheral heating part 40.

The annealing part 50 anneals a portion of the glass substrate 1 heated by the main heating part 30, to a temperature equal to or lower than the strain point of the glass. It is preferable that a terminal end of the heating region (annealing region) heated by the annealing part 50 substantially coincides with the terminal end of the heating region (peripheral heating region) heated by the peripheral heating part 40, in the relative movement direction of the glass substrate 1. In the glass substrate 1, the temperature of the portion passing through the terminal end on the annealing region is preferably a temperature equal to or higher than the temperature of the portion passing through the terminal end of the peripheral heating region, as well as the temperature in the vicinity thereof. Accordingly, in the glass substrate 1, the temperature difference between the portion passing through the main heating region and the annealing region, and the portion passing through the peripheral heating region becomes small, which can suppress generation of residual tensile stress at the boundary even if the glass substrate is cooled afterwards. It may be possible to generate compressive stress applied to the boundary depending on the conditions of heating (annealing).

The annealing part 50 of this embodiment includes a high temperature heater 51 arranged on the most upstream side in the relative movement direction of the glass substrate 1, a medium temperature heater 52 arranged adjacent to the high temperature heater 51 and arranged downstream of the high temperature heater 51, and a low temperature heater 53 arranged adjacent to the medium temperature heater 52 and arranged downstream of the medium temperature heater 52.

The high temperature heater 51 heats near the polishing portion 10a of the plate surface near of the glass substrate 1 which become high temperature by performing the polishing process, to a temperature slightly lower than the softening point of the glass (for example, 800° C. which is the same as the temperature in the main heating part 30). The high temperature heater 51 has a certain width in both the relative movement direction of the glass substrate 1 and the direction perpendicular thereto. Therefore, the temperature of the edge of the glass substrate 1 to be polished locally rises to about 1000° C. by laser irradiation with the first heating part 10. In the process of passing through the region heated by the high temperature heater 51, the temperature drops to about 800° C., which is almost the same as the peripheral portion, and the temperature difference can be almost eliminated.

The medium temperature heater 52 anneals a portion of the glass substrate 1 heated by the high temperature heater 51, to medium temperature between the softening point and the strain point of the glass (for example, 700° C.).

The low temperature heater 53 anneals a portion of the glass substrate 1 heated by the medium temperature heater 52, to the temperature slightly lower than the strain point of the glass (for example, 500° C.).

In this configuration, a portion of the glass substrate 1 passing through the main heating region subsequently passes through the annealing region (in other words, subsequently passes through each region heated by the high temperature heater 51, the medium temperature heater 52, and the low temperature heater 53), and thereby such portion is cooled to the temperature lower than the strain point with a temporally gradual temperature gradient. This can cool the glass substrate 1 with little strain, and prevent cracking and chipping of the glass substrate 1.

The annealing part 50 of this embodiment includes heaters with three temperature stages, the high temperature heater 51, the medium temperature heater 52, and the low temperature heater 53, but not limited thereto. That is, the annealing part 30 may include a heater with the temperature stages more subdivided than the above-described heaters, or may include the heater with the temperature stages rougher than the above-described heaters (for example, two stages of medium temperature and low temperature).

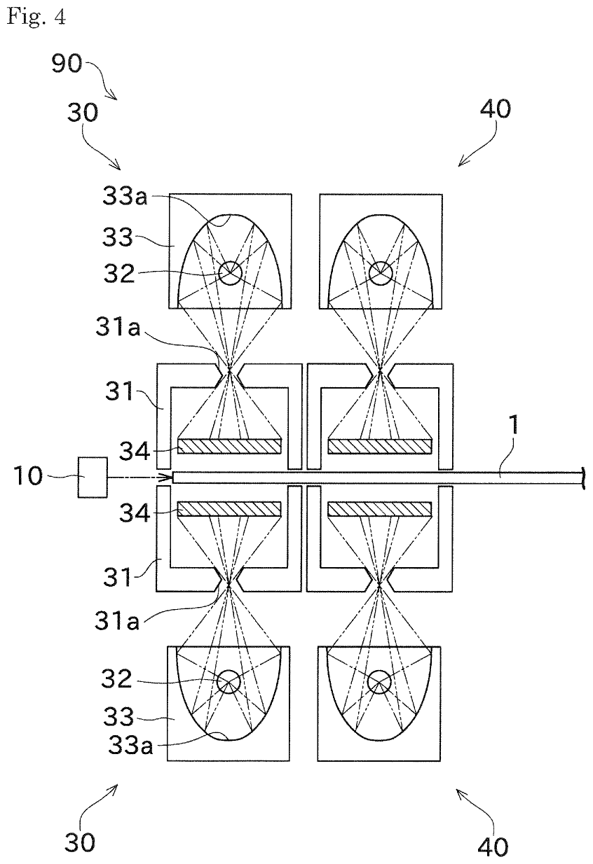

In the following, a specific configuration of the main heating part 30 will be described with reference to FIG. 4. FIG. 4 is a view schematically showing each configuration of the first heating part 10 and the second heating part 20. A two-dot chain line in the drawing schematically shows irradiated light beam.

The main heating part 30 shown in FIG. 4 has a pair of heat insulating casing (heat insulators) 31, a pair of halogen lamps (heat sources) 32, a pair of concave mirrors 33, and a pair of metal members 34. The heat insulating casing 31, the halogen lamps 32, the concave mirrors 33, and the metal members 34 are arranged so as to be symmetrical with respect to the glass substrate 1.

Each heat insulating casing 31 is arranged so as to cover one side of the thickness direction of the glass substrate 1. Each heat insulating casing 31 made of the known heat insulator has a box shape whose side close to the glass substrate 1 is opened. Each heat insulating casing 11 is arranged so as to surround the above-described main heating region. As a result, a heat-insulating space is formed within each heat insulating casing 31. A slit-like light passage 31a for passing light beam from each halogen lamp 32 is formed through a wall portion of each heat insulating casing 31 far from the glass substrate 1. As such, the main heating part 30 heats a portion of the glass substrate 1 to be heated, which is covered with each heat insulating casing 31. Therefore, heat cannot be easily released, and the glass substrate 1 can be efficiently heated.

Due to power supply, each halogen lamp 32 irradiates light beam for heating the glass substrate 1. Since the halogen lamp 32 of this embodiment is arranged outside each heat insulating casing 31, maintenance of each halogen lamp 32 is facilitated.

Each concave mirror 33 is configured to cover each halogen lamp 32, and has a reflecting surface 33a with a curved cross-sectional shape. The reflecting surface 33a is configured to reflect light beam irradiated by each halogen lamp 32 and guide the reflected light to the inside of each heat insulating casing 31 while forming a focal point inside or near the light passage 31a. Accordingly, the light beam of each halogen lamp 32 is concentrated inside each heat insulating casing 31, which can efficiently heat the glass substrate 1. The focal point is formed inside or near the light passage 31a, and thereby the size of an opening which is formed in the heat insulating casing 31 in order to form the light passage 31a. This can suppress deterioration of a heat-insulating effect.

Each metal member 34 is arranged inside the heat insulating casing 31. More specifically, each metal member 34 is arranged between the light passage 31a and the glass substrate 1. The metal member 34 having a plate shape is made of a heat resistant material such as stainless steel, Hastelloy, Inconel, or the like. In such configuration, the light beam from each halogen lamp 32 passes through the light passage 31a, and such light beam is irradiated to each metal member 34. The radiant heat from each metal member 34 whose temperature is raised is thus irradiated to the glass substrate 1. As such, the radiant heat from each metal member 34 is utilized to heat, which can sufficiently heat the glass substrate 1 even when using a heat source (for example, the halogen lamp 32 of this embodiment) for irradiating the light beam with low absorptivity to the glass. As described above, in the edge finishing device 90 of this embodiment, since a reasonable halogen lamp or the like can be used as a heat source, manufacturing cost can be reduced.

The peripheral heating part 40 has the same configuration as the main heating part 30, as shown in FIG. 4. In this embodiment, each of the high temperature heater 51, the medium temperature heater 52, and the low temperature heater 53 which are included in the annealing part 50 has the same configuration as the main heating part 30, not shown in the drawings. The heating temperature of each heating part can be appropriately adjusted by adjusting the amount of electric power to be supplied to each halogen lamp 32 or adjusting the distance from each halogen lamp 32 to a portion of the glass substrate 1 to be heated.

The first heating part 10 may have the same configuration as the main heating part 30 and the like, although not shown in figures.

However, it is not necessary that all of the main heating part 30, the peripheral heating part 40, and the annealing part 50 include halogen heaters. For example, a part or all of the main heating part 30, the peripheral heating part 40, and the annealing part 50 may be replaced by heaters with different configuration (for example, a sheathed heater).

In this manner, the second heating part 20 of this embodiment partially heats the glass substrate 1 partly before and after performing the polishing process (edge finishing process) on the glass substrate 1 by the first heating part 10, and at the same time of performing the polishing process. Accordingly, it is possible to suppress the occurrence of residual tensile stress which is particularly likely to be a problem when the glass substrate 1 is heated by laser beam. It is also possible to generate a compressive stress and improve the strength of the glass substrate 1 depending on the heating conditions. Further, by polishing the edge of the glass substrate 1, the strength of the edge of the glass substrate 1 can be improved. Thereby, cracking or chipping of the glass substrate 1 can be effectively prevented.

In this embodiment, since the polishing process is performed by the heating and melting method as described above, there is no occurrence of glass cullet during the edge finishing process of the glass substrate 1, and also there is no need to perform powerful cleaning process for removing the glass cullet after the edge finishing process. This can reduce the number of steps and an environmental burden.

If a measure of mechanical polishing like the prior art is adopted as a measure for finishing the edge of the glass substrate 1, a plurality of types of grinding wheels having different particle sizes are generally required. This causes a problem where the edge finishing device is large. In addition, the grinding wheel is a consumable item, so it needs to be exchanged frequently. This causes a problem of a corresponding running cost. In this regard, in the edge finishing device 90 of this embodiment, in the edge finishing device 90, a mechanical polishing process like the prior art is not performed, these problems are not caused.

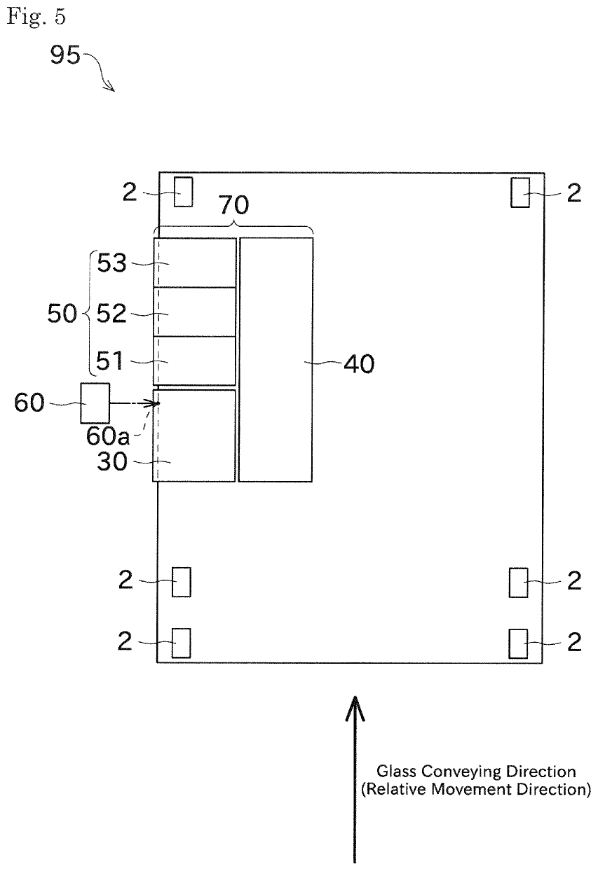

The edge finishing device 90 of this embodiment further includes a repair edge finishing device 95 for performing a heat treatment for repairing an unevenness or minute flaw of the edge of the glass substrate 1 which occur after finishing the edge and a vicinity thereof of the glass substrate 1 by heating of the first heat part 10 and second heat part 20. FIG. 5 is a plan view schematically showing the repair edge finishing device 95 and the glass substrate 1 whose edge is repaired by the repair edge finishing device 95. In FIG. 5 and the following description, members and devices of similar to those of the edge finishing device 90 assign the same reference numerals and the detailed description of those will be denoted.

An example of an occurrence of “an unevenness or minute flaw of the edge of the glass substrate 1 which occur after finishing the edge” as described above, it is supposed that the flaw of the edge occur by hitting the edge of the glass substrate 1 into a structure such as a pole or the like in a conveyance process of conveying the glass substrate 1 after the edge finishing process.

As shown in FIG. 5, the repair edge finishing device 95 includes a first heating part 60 having the same configuration as the first heating part 10 of the edge finishing device 90 and a second heating part 70 having the same configuration as the second heating part 20 of the edge finishing device 90. The first heating part 60 and the second heating part 70 heat the glass substrate 1 again, which has the unevenness or the like after the edge finishing process, while conveying along a conveyance path configure to be the same as the conveyance path of the edge finishing device 90. As a result of heating, the unevenness can become smooth (can be removed) by melting the edge of the glass substrate 1. It is preferable to arrange the glass substrate so that one side having the unevenness or the like later of the four side of the glass substrate 1 is corresponding to the laser beam irradiation position 60a. This can perform the repair process efficiently. Further, it may be possible to perform the repair process by irradiating only a portion where the unevenness or the like occurs later of the edge of the glass substrate 1.

<First Modification>

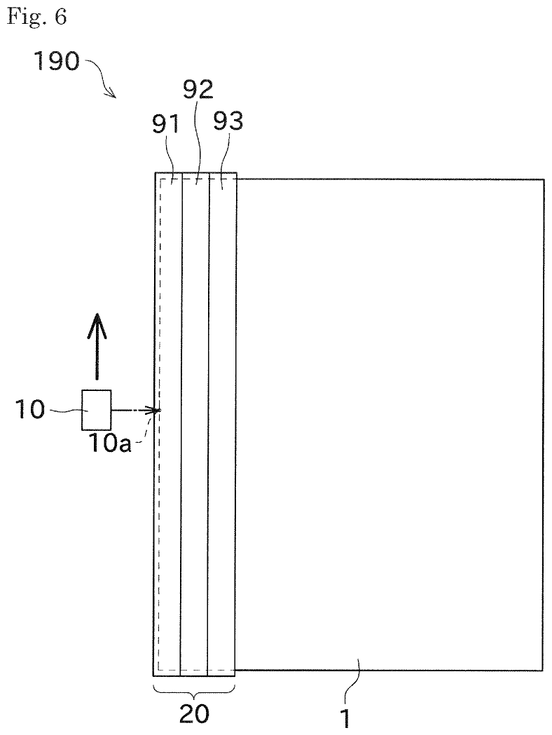

Next, an edge finishing device 190 corresponding to a modification of the edge finishing device 90 will be described with reference to FIG. 6. FIG. 6 is a plan view schematically showing the edge finishing device 190 according to a first modification.

The edge finishing device 190 includes a first heating part 10 and a second heating part 20 including a high temperature part 91, a medium temperature part 92, and a low temperature part 93.

The edge of the glass substrate 1 mechanically chamfered by grinding process is finished by the first heating part 10 of the edge finishing device 190 so that the edge is melt by heat and the edge become smooth. In this modification, any one of the four sides of the edge of the glass substrate 1 is heat treated by the common first heating part 10 and the second heating part 20.

The first heating part 10 of the first modification is configured to move from one end to the other end along the one side of the glass substrate 1 while being positioned so that an end surface of the glass substrate 1 is located at a laser beam irradiation position 10a. The laser beam from the first heating part 10 is irradiated onto the end surface of the glass substrate 1 at the polishing position 10a, and the end surface of the glass substrate 1 is melted at a high temperature (for example, 1000° C.), whereby polishing processing can be achieved.

In the vicinity of the first heating part 10, the second heating part 20 is arranged so as to face the plate surface near the edge (edge portion) of the side on which the polishing process is performed. The second heating part 20 is arranged over a slightly longer distance from the relatively longer side of the sides of the glass substrate 1. Thereby, the second heating part 20 can cover the plate surface near the edge portion of the edge on which the polishing process is performed from one end to the other end, and the heating is completed once.

The high temperature portion 91 is arranged in close proximity to the polishing position 10a, and practically heats the glass substrate 1. The high temperature portion 91 heats a facing region of the glass substrate 1 to a temperature near the softening point of the glass and a temperature slightly lower than the softening point (for example, 800° C.). By the high temperature portion 91, the vicinity of the edge of the glass substrate 1 before the polishing process can be preheated, and the edge of the glass substrate 1 after the polishing process can be annealed.

Thereby, the amount of increasing temperature accompanying the polishing process of the first heating part 10 can be reduced.

As shown in FIG. 6, when viewed in the thickness direction of the glass substrate 1, the intermediate temperature portion 92 is arranged opposite to the polishing position 10a (the side where the polishing process is performed) via the high temperature portion 91, and is arranged adjacent to the high temperature portion 91. The intermediate temperature portion 92 heats a facing region of the glass substrate 1 to a temperature slightly higher than the strain point of the glass and a temperature at which the heating temperature of the higher temperature portion 91 is lower (for example, 650° C.).

As shown in FIG. 6, when viewed in the thickness direction of the glass substrate 1, the low temperature portion 93 is arranged opposite to the high temperature portion 91 via the intermediate temperature portion 92, and is arranged adjacent to the intermediate temperature portion 92. The low temperature portion 93 heats the facing region of the glass substrate 1 to a temperature equal to or lower than the strain point of the glass (for example, 550° C.).

Thereby, in the direction perpendicular to the side where the polishing process is performed, a temperature of a boundary between the portion which is heated by the first heating part 10 to the high temperature in order to perform the polishing process and the portion which is not heated at all is low temperature stepwisely as a portion goes away from the polishing position 10a. Therefore, in the glass substrate 1, positional temperature gradient of the boundary between the heated portion and the unheated portion becomes gentle. Even when the glass substrate 1 is cooled after the edge finishing process, residual tensile stress hardly generates at the boundary between the heated portion and the unheated portion.

After the polishing process is performed from one end to the other end of one side of the glass substrate 1, the glass substrate 1 is moved in a direction separating from the first heating part 10, and is rotated by 90°. Then, the other side of the glass substrate 1 is placed close to the first heating part 10 so that the other side of the glass substrate 1 is in the state of the polishing position 10a of the first heating part 10. By changing the direction of the glass substrate 1 in this manner, heat treatment is repeatedly performed, and polishing is performed on all sides of the glass substrate 1.

According to the first modification described above, the temperature of the second heating part 20 is only three steps, and the configuration can be made simpler.

<Second Modification>

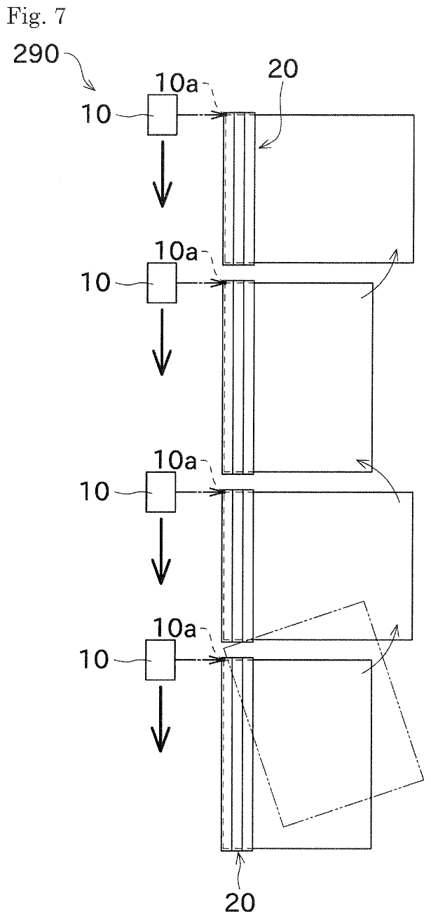

Next, an edge finishing device 290 corresponding to a modification of the edge finishing devices 90 and 190 will be described with reference to FIG. 7. FIG. 7 is a plan view schematically showing the edge finishing device 290 according to a second modification.

The edge finishing device 290 includes four first heating parts 10 and four second heating parts 20 so as to correspond to each side of the glass substrate 1 in a one-to-one correspondence. Each of the first heating parts 10 are configured to move from one end to the other end along the one side of the glass substrate 1 while being positioned so that an end surface of the glass substrate 1 is located at a laser beam irradiation position 10a. Each of the second heating parts 20 include the high temperature portion 91, the intermediate temperature portion 92, and the low temperature portion 93, similarly to the configuration of the first modification. Thereby, the amount of increasing temperature accompanying the polishing process of the first heating parts 10 can be reduced. Therefore, in the glass substrate 1, positional temperature gradient of the boundary between the heated portion and the unheated portion becomes gentle. Even when the glass substrate 1 is cooled after the edge finishing process, residual tensile stress hardly generates at the boundary between the heated portion and the unheated portion.

The first heating part 10 and the second heating part 20 corresponding to the four sides are arranged alternately in a row in correspondence with the long side counterparts and the short side counterparts. After polishing from one end to the other end of one side of the glass substrate 1, the glass substrate 1 is rotated by 90° and then conveyed to the first heating part 10 and the second heating part 20 on the downstream side. Thereby, polishing process is performed from one end to the other end of the other side of the glass substrate 1. By repeating the change of the direction of the glass substrate 1, the conveyance to the first heating part 10 and the second heating part 20 on the downstream side and the heat treatment, the polishing process is performed smoothly on all sides of the glass substrate 1.

According to the second modification, the first heating parts 10 and the second heating parts 20 corresponding to the four sides can be assembled along the manufacturing line of the glass substrate 1 (work piece) provided in the factory. Thereby the polishing process can be smoothly performed to all of sides in the manufacturing line.

<Third Modification>

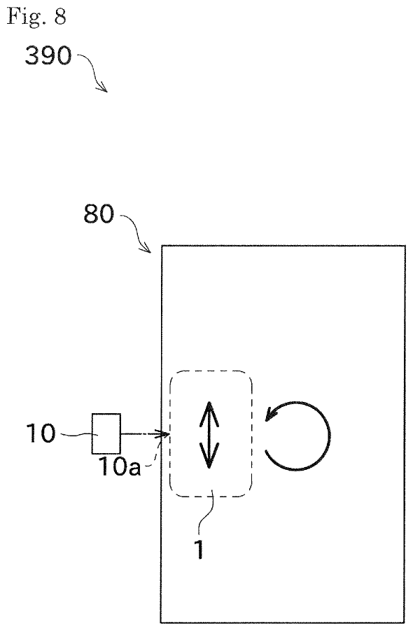

Next, an edge finishing device 390 corresponding to a modification of the edge finishing devices 90, 190, and 290 will be described with reference to FIG. 8.

The edge finishing device 390 includes a first heating part 10 that is fixedly arranged, and a second heating part 80 that heats an entire plate surface of the glass substrate 1 at a time. The first heating part 10 is positioned such that the laser beam irradiation position 10a coincides with the end surface of the glass substrate 1. The glass substrate 1 can move in parallel so that the one end to the other end of one side can be sequentially arranged in the laser beam irradiation position 10a. After performing the treatment to one side of the glass substrate 1 by the first heating part 10 is completed, the glass substrate 1 can be rotated by 90°, and the one end to the other end of another side can be sequentially arranged in the laser beam irradiation position 10a. In this manner, all the sides of the glass substrate 1 can be polished by the first heating part 10.

The second heating part 80 heats the plate surface of the glass substrate 1 before and after performing the polishing process by the first heating part 10, and at the same time of performing the polishing process. The second heating part 80 can adjust a heat temperature to the flat surface of the glass substrate 1.

Before the edge of the glass substrate 1 is polished by the first heating part 10, the surface of the glass substrate 1 is entirely heated (preheated) by the second heating part 80. The second heating part 80 heats the glass substrate 1 to a temperature near the softening point of the glass and a temperature slightly lower than the softening point (for example, 800° C.).

Then, while the second heating part 80 heats the plate surface of the glass substrate 1 at a temperature close to the softening point of the glass, the polishing process is performed on the edge by the first heat part 10.

After the polishing process is performed on the edge of the glass substrate 1, the entire plate surface of the glass substrate 1 is continuously heated by the second heating part 80, hut the temperature thereof is stepwise (or smoothly) lower, and finally it becomes the temperature below the strain point of the glass (for example, 550° C.).

Thereby, the rapid temperature rise of the plate surface of the glass substrate 1 accompanying the polishing process by the 1st heating part 10 can be moderated. Positional temperature gradient of the plate surface of the glass substrate 1 becomes gentle. Even when the glass substrate 1 is cooled after the edge finishing process, residual tensile stress hardly generates.

It is supposed that there is a various kinds of glass such as a cover glass or a strengthened glass and the like as

the glass substrate 1 whose edge is finished by the edge finishing device 390. The configuration of the edge finishing device 390 according to the third modification is preferable for finishing the edge of a small sized glass substrate 1.

As a further modification of the third modification, the second heating part 80 may be divided into a preheating part that entirely preheats the plate surface of the glass substrate 1 (for example, a temperature rises to 800° C.), a temperature rising part that entirely heats the plate surface of the glass substrate 1 at a temperature close to the softening point of the glass (for example, at 900° C.), and annealing part that entirely anneals the plate surface of the glass substrate 1 (for example, as far as 550°). These parts may be arranged along the manufacturing line of the glass substrate 1 (work piece).

In the following, a method for finishing the edge of the glass substrate 1 by using the edge finishing device 90 will be briefly described. FIG. 9 is a block diagram showing the flow of the steps of the method for finishing of the edge of the glass substrate 1.

First, the edge (edge portion) of the glass substrate 1 cut to an appropriate size according to the product size or the like is mechanically chamfered by the grinding process (step S101, grinding step). As shown in FIG. 9, the surface of the edge of the glass substrate 1 after mechanical chamfering has minute unevenness.

Then, the plate surface of the glass substrate 1 before the finishing process of the edge, that is, the plate surface arranged on the upstream side of the polishing position 10a in the relative movement direction, is preheated by heating of the main heating part 30. (Step S102, preheating step).

Then, at the polishing position 10a, the edge of the glass substrate 1 is heated and melted by the first heating part 10, so that the unevenness on the surface of the edge is smoothed, and the surface is finished as a mirror surface (step S103, smoothing step). As shown in FIG. 9, after the finishing process has performed, the surface of the edge of the glass substrate 1 is substantially free from unevenness.

Then, the plate surface of the glass substrate 1 after the finishing process of the edge, that is, the plate surface arranged on the downstream side of the polishing position 10a in the relative movement direction, is annealed by heating of the annealing part 50, so that the temperature is stepwisely changed to a low temperature (step S104, annealing step). At this time, in the glass substrate 1, positional temperature gradient of the boundary between the heated portion and the unheated portion becomes gentle. Even when the glass substrate 1 is cooled after the edge finishing process, residual tensile stress does not generate at the boundary between the heated portion and the unheated portion. Since a compressive stress generates depending on the heating conditions, the strength of the glass substrate is improved.

Then, as shown in FIG. 9, in the case where unevenness or minute flaws occur in the edge of the glass substrate 1 afterwards, the repair edge finishing device 95 that has the same configuration as the first heating part 10 and the second heating part 20 heats the edge of the glass substrate 1 again (step S105, repairing step). Thereby, the polishing process is performed again, so that unevenness or minute flaws which occur afterwards can be removed.

By the flow of the above steps, the surface of the edge of the glass substrate 1 is finished to be substantially free from unevenness (see FIG. 9).

As described above, the edge finishing device 90 of this embodiment includes the first heating part 10 and the second heating part 20. The first heating part 10 heats the edge of the glass substrate 1 to melt the edge for smoothing an unevenness. The second heating part 20 heats near the position to be smoothed by the first heating part 10 of the plate surface of the glass substrate 1 at a temperature lower than a heating temperature of the first heating part 10.

Accordingly, the edge of the glass substrate 1 is melted by heating by the first heating part 10. Thereby, the unevenness such as flaws of the edge is smoothed and the strength of the edge can be improved. Since the near position to be smoothed of a plate surface is heated (by the second heat part 20) at a temperature lower than a heating temperature of the first heating part 10, there is a portion where the second heating part 20 (specifically, main heating part 30) heats to medium temperature between a portion heated to high temperature for smoothing and an unheated portion. Thereby, residual tensile stress hardly generates. It may be possible to generate compressive stress depending on the conditions of heating. This can prevent cracking and chipping of the glass substrate 1.

In the edge finishing device 90 of this embodiment, the edge of the glass substrate 1 is finished by heating for smoothing by the first heating part 10 after the edge is chamfered by a grinding process.

Accordingly, after the surface is chamfered by the grinding process, the edge is smoothed by heating of the first heating part 10. Therefore, the edge of the glass substrate 1 can be finished in a short time.

In the edge finishing device 90 of this embodiment, when an unevenness occurs on the edge of the glass substrate 1 after the edge of the glass substrate 1 is heated and finished, a heating part that is the repair edge finishing device 95 having the same configuration as the first heating part 10 and the second heating part 20 heats the edge again to smooth the unevenness occurring afterwards.

Accordingly, in the case where the edge of the glass substrate 1 is finished by a certain method and the flaws or the like occur afterwards, the flaws or the like can be repaired. Therefore, the occurrence of defective products can be reduced and a production yield can be improved.

In the edge finishing device 90 of this embodiment, the second heating part 20 heats a main heating region (by the main heating part 30) facing a portion of the plate surface of the glass substrate 1 near the smoothed position at a temperature near a softening point of the brittle material, and heats a peripheral heating region (by the peripheral heating part 40) facing a portion of the plate surface of the glass substrate 1 that is adjacent to the main heating region and is opposite side of the smoothed position across the main heating region at a temperature lower than a strain point of the brittle material.

Accordingly, the glass substrate 1 is heated to low temperature stepwisely as separating from the position where the plate surface is smoothed. The temperature difference between the heated portion and the unheated portion becomes small. Therefore, residual tensile stress more hardly generates at the boundary between the heated portion and the unheated portion even when the glass substrate 1 is cooled after the edge finishing process. It may be possible to generate compressive stress depending on the conditions of heating. This can prevent cracking and chipping of the glass substrate.

In the edge finishing device 90 of this embodiment, the second heating part heats near a region smoothed of the glass substrate 1 that is arranged inside the heat insulating casing 31.

Accordingly, heat cannot be easily released, and the near region smoothed of the glass substrate 1 can be efficiently heated.

In the edge finishing device 90 of this embodiment, the second heating part 20 includes the halogen lamps 32 as a heat source. The light passage 31a through which a light beam from the halogen lamps 32 passes is formed in the heat insulating material 31. The focus of the light beam from the halogen lamps 32 is located in the light passage 31a or heat insulating material 31 near the light passage 31a.

Accordingly, since the light passage 31a can be formed small, heat can be easily accumulated in the space inside the heat insulating casing 31. Thereby, heating can be performed efficiently.

The edge finishing device 90 of this embodiment includes the metal member 34 that is arranged between the light passage 31a and the plate surface of the glass substrate 1 heated by the second heating part 20 (main heating part 30).

Accordingly, the near region smoothed of the glass substrate 1 can be efficiently heated by the radiant heat from each metal member 34. Therefore, the near region smoothed of the glass substrate 1 can be heated enough even when using a heat source for irradiating the light beam with low absorptivity to the glass.

The method for finishing the edge of this embodiment includes the smoothing step (step S103) for smoothing an unevenness of the edge of the glass substrate 1 by heating and melting the edge by the first heating part 10 at a temperature higher than a heating temperature of the second heating part 20 while the second heating part 20 heats near a position to be smoothed of the plate surface of the glass substrate 1.

Accordingly, the edge of the glass substrate 1 is melted by heating by the first heating part 10. Thereby, the unevenness such as flaws of the edge is smoothed and the strength of the edge can be improved. Since the near position to be smoothed of a plate surface is heated (by the second heat part 20) at a temperature lower than a heating temperature of the first heating part 10, there is a portion where the second heating part 20 heats to medium temperature between a portion heated to high temperature for smoothing and an unheated portion. Thereby, residual tensile stress hardly generates. It may be possible to generate compressive stress depending on the conditions of heating. This can prevent cracking and chipping of the glass substrate 1.

The method for finishing the edge of this embodiment includes the grinding step (step S101) for chamfering the edge of the glass substrate 1 by grinding before the smoothing step (step S103).

Accordingly, after the surface is chamfered by the grinding process, the edge is smoothed by heating of the first heating part 10. Therefore, the edge of the glass substrate 1 can be finished in a short time.

The method for finishing the edge of this embodiment includes the repairing step (step S105) for smoothing an unevenness occurring after the smoothing step (Step S103) by heating the edge again by a heating part that is the repair edge finishing device 95 having that has the same configuration as the first heating part 10 and the second heating part 20.

Accordingly, in the case where the edge of the glass substrate 1 is finished by a certain method and the flaws or the like occur afterwards, the flaws or the like can be repaired. Therefore, the occurrence of defective products can be reduced and a production yield can be improved.

The method for finishing the edge of this embodiment includes the preheating step (step S102) for preheating (by the main heating part 30) near the position to be smoothed by the first heating part 10 of the plate surface of the glass substrate 1 before the smoothing step (step S103).

Accordingly, since the near position to be smoothed of the plate surface of the glass substrate 1 is preheated (by the main heating part 30), the amount of increasing temperature accompanying the smoothing step can be reduced.

The method for finishing the edge of this embodiment includes the annealing step (step S104) for annealing (using the annealing part 50) near the position smoothed by the first heating part 10 of the plate surface of the glass substrate 1 after the smoothing step (step S103).

Accordingly, a temperature change of the near position smoothed of the plate surface is gentle when the glass substrate 1 is cooled. Therefore, the residual tensile stress hardly generates at the near position smoothed. This can prevent cracking and chipping of the glass substrate 1.

While a preferred embodiment and modifications of the present invention has been described above, the above-described configuration can be modified, for example, as follows.

In the above-described embodiment, the brittle material substrate is the glass substrate, but not limited thereto. For example, a sapphire substrate or a ceramic substrate may be used instead. That is, the present invention can be widely applied to finishing an edge of a substrate made of the brittle material (material with small strain until break).

Further, the brittle material substrate may be a glass substrate made of chemically strengthened glass. In general, a strength of a main plate surface of chemically strengthened glass is high, but the strength of the edge (edge portion) which is cut to an appropriate size according to the product size or the like is low. Therefore, an overall strength of the substrate can be high by performing the edge finishing process on the edge like that.

A direction where the first heat part 10 irradiates the laser beam to the polishing position 10a is, as shown in FIG. 2, not limited to the direction perpendicular to the thickness direction of the glass substrate 1. The direction may be properly inclined. The irradiation direction of the laser beam is, as shown in FIG. 1, not limited to the direction perpendicular to the relative movement direction of the glass substrate 1. The direction may be properly inclined.

In the above-described embodiment, the main heating part 30 includes a pair of the heat insulating housing 31, the halogen lamp 32, the concave mirror 33, and the metal member 34 (see FIG. 4), and these members are arranged so as to interpose the glass substrates 1, but the present invention is not limited thereto. It is assumed that these members are provided on only one side of the plate surface of the glass substrate 1. Similarly, the peripheral heating part 40 and the annealing part 50 may be provided with a member such as a light source or a heat insulating material only on one side of the plate surface of the glass substrate 1.

In the above-described embodiment, the edge finishing process is performed by the first heating part 10 that is a laser irradiation device, but this is not limited thereto. For example, instead of the laser beam, the halogen heater or the sheathed heater may be used for finishing the edge of the glass substrate 1. When the edge is finished by irradiating the light beam from the halogen heater, for example, each configuration of the heat insulating casing 31, the concave mirror 33, the metal member 34, etc. shown in FIG. 4, are applied. Accordingly, even when the light source (for example, the halogen lamp) which irradiates the light beam with low absorptivity to the brittle material is used, the glass substrate 1 can be heated to the temperature required for the edge finishing process.

In order to effectively heat the glass substrate 1, a reflector, a mirror, or the like for reflecting the light beam may be attached to an inner surface (internal surface) of the heat insulating casing 31.

The metal member 34 may be omitted, and the light beam from the halogen lamp 32 may be directly irradiated to the glass substrate 1.

The glass substrate 1 to which the edge finishing process is subjected may have a vertical attitude, for example, instead of a horizontal attitude as shown in FIG. 1.

The first heating part 10 and the second heating part 20 may be arranged on both sides in the width direction of the glass substrate 1, and the finishing process may be simultaneously performed on the both sides.

In the above-described embodiment, the repair edge finishing device 95 which is provided separately from the edge finishing device 90 performs the repairing step (step S105) in order to smooth the unevenness of the edge of the glass substrate afterwards. The edge finishing device 90 instead of the repair edge finishing device 95 may perform the repairing step.

In the above embodiment, when the glass substrate 1 is subjected to the edge finishing process, a part of the glass substrates 1 is heated by the second heating part 20, but the present invention is not limited thereto.

The edge of the glass substrate may be sequentially heated by the first heat part 10 while heating the entire surface of the glass substrate by the second heating part 20.

### DESCRIPTION OF THE REFERENCE NUMERALS

1 glass substrate (brittle material substrate)
10 first heating part
20 second heating part
30 main heating part
40 peripheral heating part
50 annealing part
60 first heating part
70 second heating part
80 third heating part
90 edge finishing device (edge finishing device for brittle material substrate)
95 repair edge finishing device (heating part)
190 edge finishing device
290 edge finishing device
390 edge finishing device

1-12. (canceled)

13. An edge finishing device for a brittle material substrate, comprising:
a first heating part configured to heat an edge of the brittle material substrate to melt the edge for smoothing an unevenness; and
a second heating part configured to heat near a position to be smoothed by the first heating part of a plate surface of the brittle material substrate at a temperature lower than a heating temperature of the first heating part.

14. The device of claim 13, wherein the edge is finished by heating for smoothing by the first heating part after the edge is chamfered by a grinding process.

15. The device of claim 13, wherein the unevenness occurs on the edge after the edge is heated and finished and wherein the device further comprising:
a further heating part having the same configuration as the first heating part and the second heating part, the further heating part configured to heat the edge again to smooth the unevenness occurring afterwards.

16. The device of claim 13, wherein the second heating part heats a main heating region facing a portion of the plate surface near the smoothed position at a temperature near a softening point of the brittle material, and heats a peripheral heating region facing a portion of the plate surface that is adjacent to the main heating region and is opposite side of the smoothed position across the main heating region at a temperature lower than a strain point of the brittle material.

17. The device of claim 13, wherein the second heating part heats near a region to be smoothed of the brittle material substrate in a state where the region is arranged inside a heat insulating material.

18. The device of claim 17, wherein the second heating part includes a heat source, wherein a light passage through which a light beam from the heat source passes is formed in the heat insulating material, and wherein a focus of the light beam from the heat source is located in the light passage or the heat insulating material near the light passage.

19. The device of claim 18, wherein the second heating part includes a metal member that is arranged between the light passage and the plate surface heated by the second heating part.

20. A method for finishing an edge of a brittle material substrate, comprising:
smoothing an unevenness of an edge of the brittle material substrate by heating and melting the edge using a first heating part at a temperature higher than a heating temperature of a second heating part while the second heating part heats near a position smoothed of a plate surface of the brittle material substrate.

21. The method of claim 20, further comprising:
chamfering the edge by grinding before the smoothing step.

22. The method of claim 21, further comprising:
smoothing the unevenness occurring on the edge after the smoothing step by heating the edge again by a further heating part that has the same configuration as the first heating part and the second heating part.

23. The method of claim 20, further comprising:
preheating near a position to be smoothed by the first heating part of a plate surface of the brittle material substrate before the smoothing step.

24. The method of claim 20, further comprising:
annealing near a position smoothed by the first heating part of a plate surface of the brittle material substrate after the smoothing step.
